(19) United States
(12) Patent Application Publication
(10) Pub. No.: US 2009/0236501 A1
(43) Pub. Date: Sep. 24, 2009

(54) PHOTON DETECTION METHOD AND CIRCUIT HAVING PHASE ADJUSTER

(75) Inventors: Seigo Takahashi, Tokyo (JP); Akio Tajima, Tokyo (JP); Akihiro Tanaka, Tokyo (JP); Wakako Maeda, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Tokyo (JP)

(21) Appl. No.: 12/409,323

(22) Filed: Mar. 23, 2009

(30) Foreign Application Priority Data
Mar. 24, 2008 (JP) 2008-074894

(51) Int. Cl. H01J 40/14

(52) U.S. Cl. 250/214 R

(57) ABSTRACT

A photon detection circuit in which photon detection is performed by applying gate pulses to a light-receiving element at predetermined periods, includes: a gate-period waveform averaging section that generates averaged waveform data by averaging sampled waveform data output from the light-receiving element in the individual predetermined periods; a phase shifting section that shifts at least one of the phases of the averaged waveform data and sampled waveform data so that a phase difference between the averaged waveform data and sampled waveform date disappears; and a discrimination section that discriminates a photon detection based on the phase-adjusted sampled waveform data relative to the phase-adjusted averaged waveform data.

### BACKGROUND OF THE INVENTION

1. Field of the Invention

This application is based upon and claims the benefit of priority from Japanese Patent Application No. 2008-074894, filed on Mar. 24, 2008, the disclosure of which is incorporated herein in its entirety by reference.

The present invention relates to a photon detection circuit that drives a light-receiving element capable of detecting a single photon, such as an avalanche photodiode, in the gated mode. More particularly, the present invention relates to a photon detection circuit and method that processes an output signal of a light-receiving element as discrete sampled data.

2. Description of the Related Art

In photon receivers, an avalanche photodiode (hereinafter, referred to as APD) is generally used as an element for detecting a single photon. Basically, the multiplication factor of an APD is made extremely high by reverse-biasing the APD above its breakdown voltage (VBd), whereby an optical current induced by a single photon is amplified to the extent that the signal amplitude is sufficiently large. Thus, it is possible for an external circuit to carry out processing.

To achieve long-distance transmission of a single photon through an optical fiber, a compound-based APD sensitive in the 1.55-um wavelength band is an optimum choice for a photon-detecting element. In a single-photon detector using a compound APD, it is essential that the APD element be cooled and that the gated mode be applied, as described in Levine, B. F., Bethea, C. G., and Campbell, J. C., “Near room temperature 1.3 um single photon counting with a InGaAs avalanche photodiode,” Electronics Letters, vol. 20, No. 14 (July 1984), pp. 596-598. A photon detection signal, which is output from the APD driven in the gated mode, is output with its waveform superimposed onto the differential waveform of a gate pulse. This differential waveform is also called “charge pulse” because the differential waveform is attributable to the parasitic capacity of the p-n junction of the APD.

As the frequency band of the circuit increases, charge pulses are observed as large amplitude, which makes it difficult to detect a small-amplitude photon detection signal. However, high-sensitive photon detection can be realized with the advent of high-accuracy charge pulse compensation schemes to solve this problem, which are proposed in the following papers:
Bethune, D. S., Risk, W. P., and Pabst, G. W., “A high-performance integrated single-photon detector for telecom wavelengths,” Journal of Modern Optics, Vol. 51, No. 9-10 (June 2004), pp. 1359-1368,
Ribordy, G., Gisin, N., Guinnard, O., Stucki, D., Wegmuller, M., and Zbinden, H., “Photon counting at telecom wavelengths with commercial InGaAs/InP avalanche photodiodes: current performance,” Journal of Modern Optics, Vol. 51, No. 9-10 (June 2004), pp. 1381-1398, and
Yoshizawa, A., Kaji, R., and Tsuchida, H., “Gated-mode single-photon detection at 1550 nm by discharge pulse counting,” APPLIED PHYSICS LETTERS, Vol. 84, No. 18 (May 2004), pp. 3606-3608.

Moreover, it is pointed out that charge pulse compensation circuits as described above have a problem of errors in charge pulse compensation due to variations in individual characteristics among elements, and a method for solving this problem is proposed in the following documents:
Takahashi, S., Tajima, A., and Tomita, A., “High-efficiency single photon detector combined with an ultra-small APD module and a self-training discriminator for high-speed quantum cryptosystems,” Technical digest of the 13th Microoptics Conference MOC′07 (October 2007), Post deadline papers, PD1, and
Japanese Patent Application Unexamined Publication No. 2006-284202 (JP2006-284202).

According to the schemes proposed in Bethune, D. S. et al., Ribordy, G. et al., and Yoshizawa, A. et al., an APD output signal is handled as an analog signal when charge pulse compensation and signal discrimination are performed. On the other hand, according to the methods described in Takahashi, S. et al. and JP2006-284202, an APD output waveform is sampled by using a high-speed analog-to-digital (AD) converter, and charge pulse compensation and signal discrimination are performed by digital signal processing (hereinafter, this scheme will be referred to as ADC scheme). According to the analog processing-based schemes, it is necessary to provide a circuit for generating a compensation signal and to adjust a delay suitably for the type of an APD and the APD-specific characteristic. However, according to the ADC scheme, since a compensation waveform is generated using past APD output waveforms, no individual adjustment is required, resulting in mass-production advantage. Hereinafter, a brief description will be given of a photon detection circuit based on the ADC scheme described in Takahashi, S. et al. and JP2006-284202.

FIG. 1A is a schematic configuration diagram of a photon detection circuit that performs charge pulse compensation and signal discrimination through digital signal processing. FIG. 1B is a waveform diagram showing an example of gate pulses and an APD output signal in this photon detection circuit. Referring to FIG. 1A, periodic gate pulses S1 (see FIG. 1B), superimposed onto direct-current bias voltage, are applied from a gate generation circuit 2 to an APD 1. Thus, an APD output signal S2 including the differential waveform of the gate pulses S1 (see FIG. 1B) is output from the APD 1. Here, an example of the waveform of the APD output signal S2 is shown when a photon enters at the timing of applying a (N+1)-th gate pulse and a received-light component due to the photon is superimposed on the differential waveform of the gate pulse.

The APD output signal S2 is sampled by a sampling circuit 3 in accordance with a sampling clock signal and output as discrete sampled data S3 (hereinafter, referred to as sampled waveform) to a gate-period waveform averaging section 4. The gate-period waveform averaging section 4 averages sampled waveforms S3 in the individual gate periods and outputs the averaged waveform S4 to a discrimination section 5. If the arrival rate of a photon is low, the averaged waveform S4 is substantially close to the differential waveform. Accordingly, the discrimination section 5 determines a difference between the sampled waveform S3 and the averaged waveform S4, thereby outputting a photon detection signal S4 in which the charge pulses are compensated.

However, in cases where an APD output signal is sampled and processed as discrete data, there are some occasions when an error in the sampled waveform is enlarged for some reason such as a jitter of a sampling clock signal, resulting in degraded accuracy in the discrimination. That is, since a signal within the range of a charge pulse has a significantly high rate of change in amplitude, the level of the signal sampled changes widely in comparison with a change in the sampling point. That is, if a sampling clock signal has a jitter, the result of sampling in the range of each charge pulse fluctuates widely even though the result is supposed to be constant essentially. This fact is a characteristic of the ADC scheme.

Such fluctuation of the sampled waveform S3 means increased errors to the discrimination section 5, which discriminates photon detection based on a difference of the sampled waveform S3 from the averaged waveform S4. Specifically, if the APD output signal S2 is sampled in accordance with a clock signal having a maximum jitter deviation expected in the system, the resultant sampled waveform S3 has levels different from those of the averaged waveform S4. When signal discrimination is performed by comparing the sampled waveform S3 and averaged waveform S4, a waveform difference due to the jitter may be erroneously discriminated and recognized as a photon detection. To reduce errors due to such erroneous discrimination, it is necessary to set a high threshold value for discrimination, which may lead to a reduction in the photon detection efficiency because of an omission of a small-signal detection. Hereinafter, the influence of a sampling jitter will be described more specifically.

FIG. 2A is a diagram showing sampling points and the waveform of the APD output signal S2, and FIG. 2B is a diagram showing a waveform deviation of the sampled waveform S3 from the averaged waveform S4 due to a sampling jitter. Referring to FIG. 2A, if sampling points deviate relative to the waveform of the APD output signal S2 as shown at sampling points A and sampling points B in FIG. 2A, it can be found that in the ranges where the level of the sampled waveform S3 widely changes with respect to time in particular, great variance occurs in the signal level.

Referring to FIG. 2B, if sampling points for the sampled waveform S3 deviate and the sampled waveform S3 is obtained as shown by filled circles relative to the averaged waveform S4 shown by open circles, variance occurs in the signal level of the sampled waveform S3 within a discrimination window, during which a photon detection is discriminated. Therefore, if signal discrimination is performed by comparing the sampled waveform S3 and averaged waveform S4, there is a possibility that a waveform difference due to the jitter is erroneously recognized as a photon detection.

### SUMMARY OF THE INVENTION

Accordingly, an object of the present invention is to provide a photon detection circuit and a photon detection method that can accomplish high-accuracy signal discrimination even if a sampling clock signal has a jitter.

According to the present invention, a photon detection circuit includes: a light-receiving element to which periodic gate pulses with a predetermined period are applied; a gate-pulse waveform averaging section for averaging sampled waveform data in the predetermined periods to generate averaged waveform data, wherein the sampled waveform data is obtained from an output signal of the light-receiving element; a phase adjuster for adjusting at least one of phases of the averaged waveform data and the sampled waveform data so that a phase difference between the averaged waveform data and sampled waveform date disappears; and a discriminator for discriminating photo detection based on a difference between the sampled waveform data and the averaged waveform data which are relatively phase-adjusted.

According to the present invention, a photon detection method using a light-receiving element to which periodic gate pulses with a predetermined period are applied, includes: averaging sampled waveform data in the predetermined periods to generate averaged waveform data, wherein the sampled waveform data is obtained from an output signal of the light-receiving element; adjusting at least one of phases of the averaged waveform data and the sampled waveform data so that a phase difference between the averaged waveform data and sampled waveform date disappears; and discriminating photo detection based on a difference between the sampled waveform data and the averaged waveform data which are relatively phase-adjusted.

According to the present invention, photon detection can be discriminated with high accuracy even if a sampling clock signal has a jitter.

### BRIEF DESCRIPTION OF THE DRAWINGS

FIG. 1A is a schematic configuration diagram of a photon detection circuit that performs charge pulse compensation and signal discrimination through digital signal processing.

FIG. 1B is a waveform diagram showing an example of gate pulses and an APD output signal in this photon detection circuit.

FIG. 2A is a diagram showing sampling points and the waveform of the APD output signal.

FIG. 2B is a diagram showing a waveform deviation of a sampled waveform from an averaged waveform due to a sampling jitter.

FIG. 3 is a block diagram showing a schematic configuration of a photon detection circuit according to an exemplary embodiment of the present invention.

FIG. 4 is a block diagram showing a configuration of a photon detection circuit according to a first example of the present invention.

FIG. 5A is a diagram showing sampling points and the waveform of an APD output signal.

FIG. 5B is a diagram for describing phase detection operation and a waveform deviation of a sampled waveform from an averaged waveform due to a sampling jitter or the like.

FIG. 5C is a diagram showing the phase-adjusted sampled waveform and averaged waveform, as well as the interpolated averaged waveform.

FIG. 6 is a block diagram showing a configuration of a photon detection circuit according to a second example of the present invention.

FIG. 7A is a diagram showing the waveform of an APD output signal.

FIG. 7B is a diagram showing a sampled waveform obtained in accordance with a sampling clock signal.

FIG. 7C is an enlarged diagram of a portion (charge pulse portion) of a sampled waveform obtained in accordance with a high-speed sampling clock signal, the portion between prior to and subsequent to a phase comparison window.

FIG. 8 is a block diagram showing a configuration of a photon detection circuit according to a third example of the present invention.

FIG. 9 is a block diagram showing a configuration of a photon detection circuit according to a fourth example of the present invention.

FIG. 10A is a diagram showing the waveform of an APD output signal.

FIG. 10B is a diagram showing a sampled waveform obtained in accordance with a high-speed sampling clock signal.

FIG. 10C is a waveform diagram showing a switch timing signal for selection of a phase comparison window and a discrimination window.

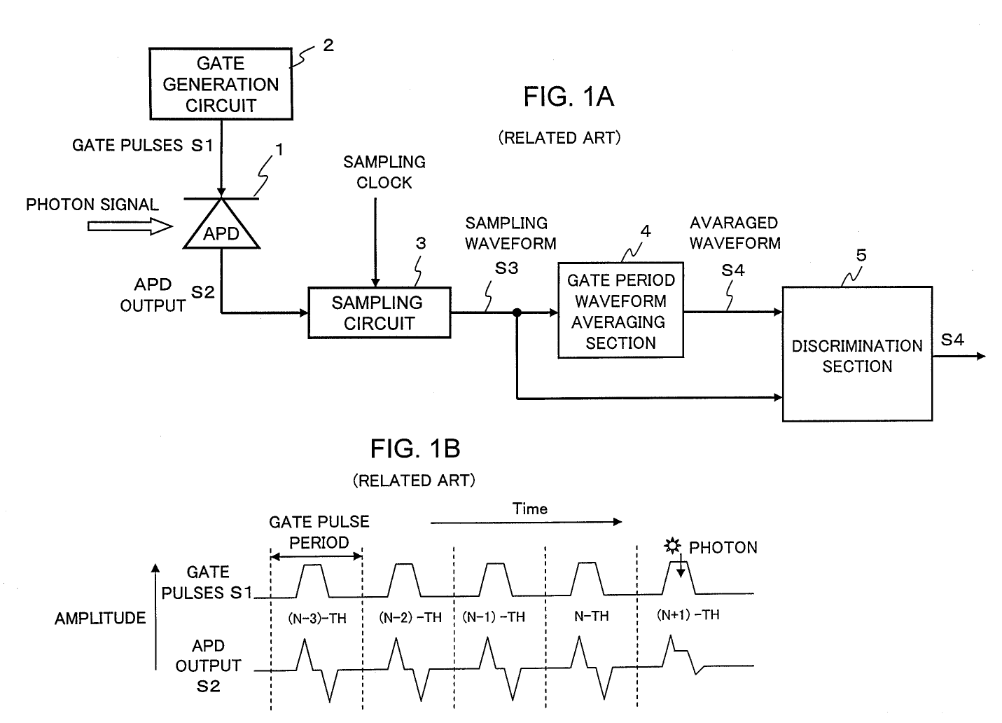

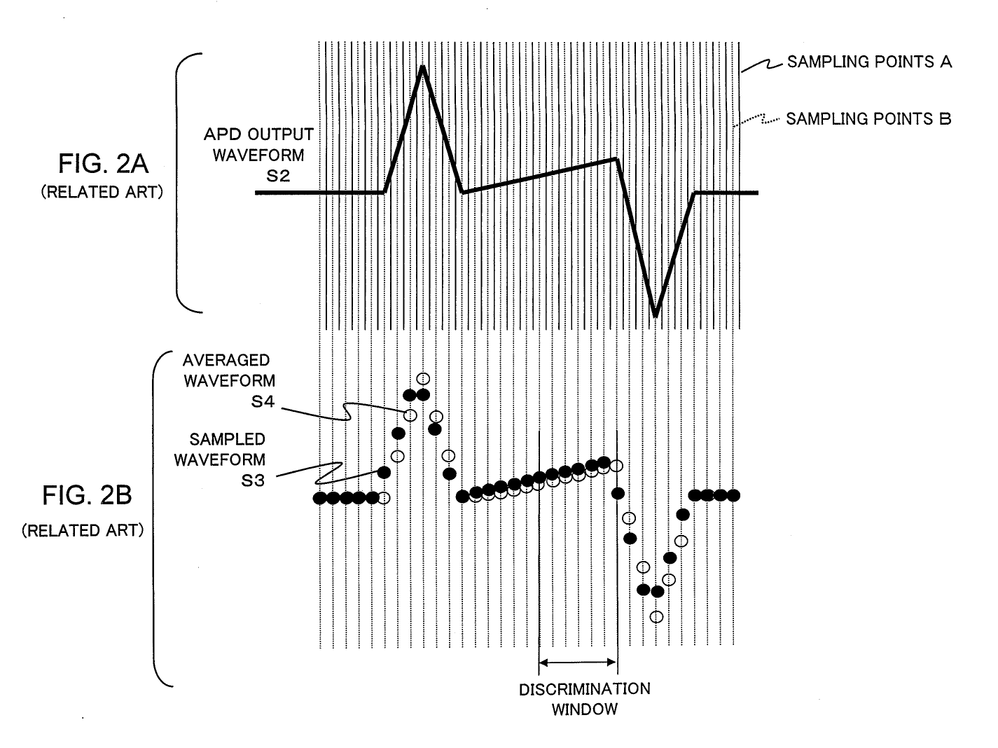

### DETAILED DESCRIPTION OF THE PREFERRED EMBODIMENTS

### 1. EXEMPLARY EMBODIMENT

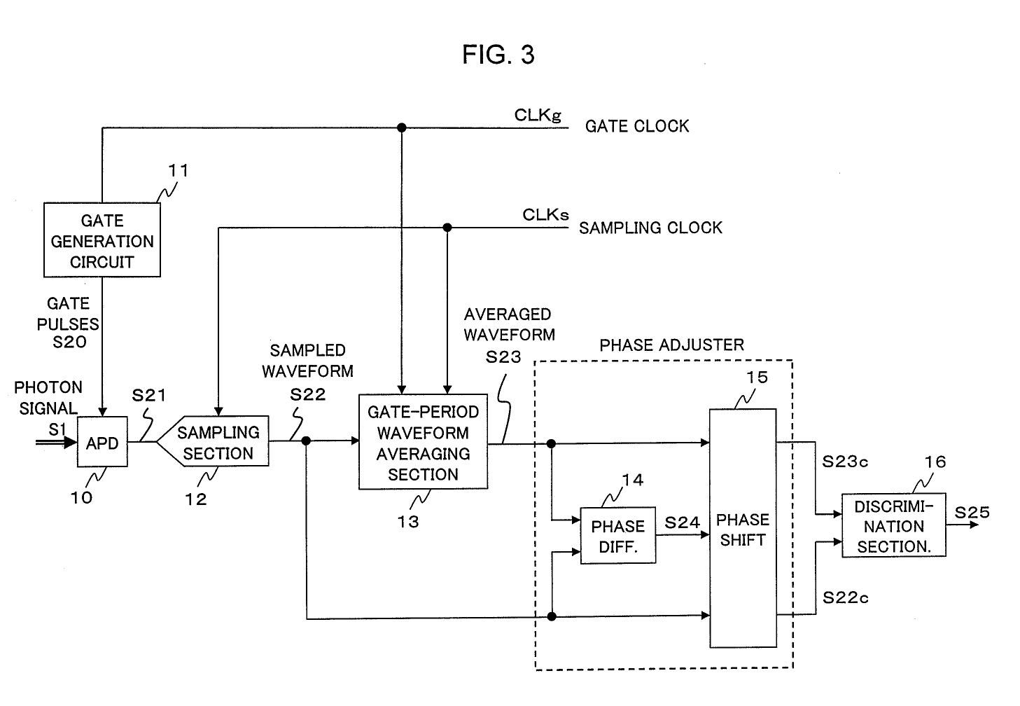

FIG. 3 is a block diagram showing a schematic configuration of a photon detection circuit according to an exemplary embodiment of the present invention. Here, as an example, a photon detection circuit is shown that uses an avalanche photodiode (APD) as a light-receiving element capable of detecting a photon by gate pulse driving.

A gate generation circuit 11 applies periodic gate pulses S20 to an APD 10 at predetermined intervals. The gate generation circuit 11 generates the periodic gate pulses S20 with gate period in accordance with a gate clock signal CLKg. Thus, the APD 10 outputs an APD output signal S21 including the differential waveform of the gate pulses S20 at the gate periods. When the incidence of a photon signal S1 occurs while periodic gate pulses S20 are being applied, output is the APD output signal S21 in which a received-light component due to the arrival of photon is superimposed onto the differential waveform of a corresponding gate pulse of the periodic gate pulses S20.

The APD output signal S21 is sampled by a sampling section 12 in accordance with a sampling clock signal CLKs. and output as discrete sampled time-series data S22 (hereinafter, referred to as sampled waveform S22) to a gate-period waveform averaging section 13. The gate-period waveform averaging section 13 receives the gate clock signal CLKg and sampling clock signal CLKs as input, averages the sampled waveform S22 in the individual gate periods at each sampling point, and then outputs the averaged time-series data S23 (hereinafter, referred to as averaged waveform S23) to a phase adjuster.

The phase adjuster includes a phase-difference detection section 14 and a phase shifting section 15. The phase-difference detection section 14 detects a phase difference by comparing the sampled waveform S22 and averaged waveform S23 within the span of a phase comparison window and outputs the phase difference as a phase difference signal S24 to the phase shifting section 15.

The phase shifting section 15 shifts the phase of any one of the sampled waveform S22 and averaged waveform S23 relative to the other so that the phase difference becomes zero. The phase shifting section 15 then outputs to a discrimination section 16 the sampled waveform S22c and averaged waveform S23c which are in phase with each other.

The discrimination section 16 detects a difference of the sampled waveform S22c with respect to the averaged waveform S23c within the span of a discrimination window and then outputs as a photon detection signal S25 the result of comparison between this detected difference and a predetermined threshold.

As described earlier, when the photon signal S1 has a low photon arrival rate, the averaged waveform S23 is substantially close to the differential waveform of the gate pulses S20. Accordingly, the discrimination section 16 can obtain the photon detection signal S25 in which charge pulses are compensated, from the difference of the sampled waveform S22c from the averaged waveform S23c.

Moreover, according to the present exemplary embodiment, input to the discrimination section 16 are the sampled waveform S22c and averaged waveform S23c which are in phase with each other. Therefore, even if a deviation of the sampling points occurs at the sampling section 12 due to a jitter of the sampling clock signal CLKs, accurate photon detection can be performed. In other words, a jitter of the sampling clock signal CLKs is estimated by the comparison between the sampled waveform S22c and averaged waveform S23c, whereby deterioration of accuracy in the signal discrimination can be prevented.

Note that functions equivalent to the sampling section 12, gate-period waveform averaging section 13, phase-difference detection section 14, phase shifting section 15, and discrimination section 16 can also be implemented by executing a program on a program-controlled processor such as a CPU.

### 2. FIRST EXAMPLE

### 2.1) Configuration

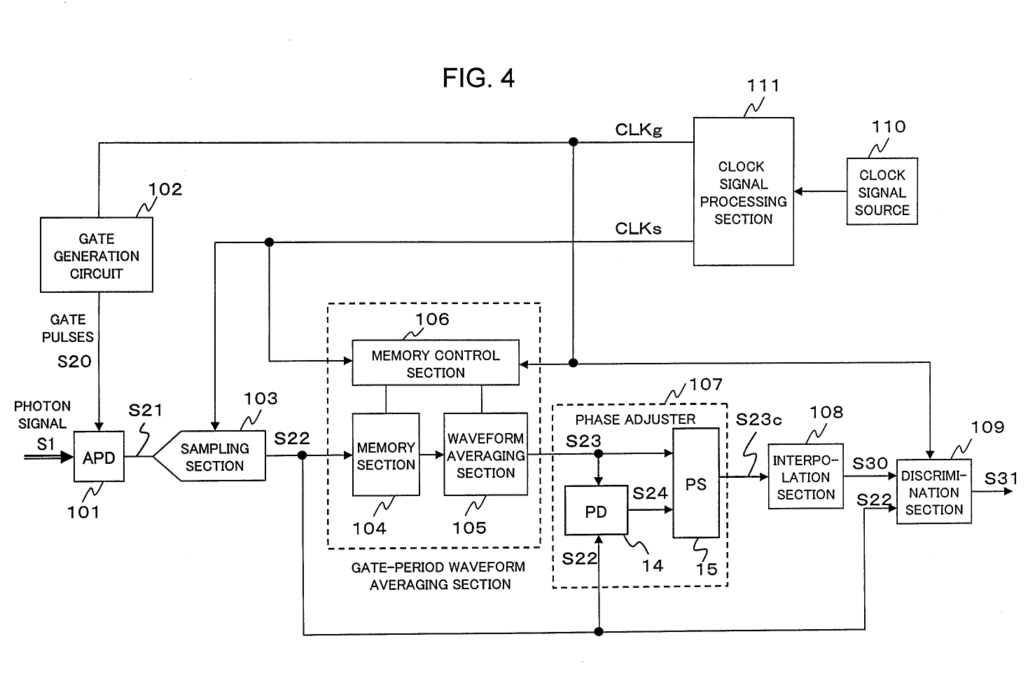

FIG. 4 is a block diagram showing a configuration of a photon detection circuit according to a first example of the present invention. Periodic gate pulses S20, superimposed onto direct-current bias voltage, are applied from a gate generation circuit 102 to an APD 101 at predetermined periods (gate periods). The gate generation circuit 102 generates periodic gate pulses S20 of a reverse bias voltage equal to or higher than the breakdown voltage (VBd) of the APD 101 at the gate periods in accordance with a gate clock signal CLKg. Thus, the APD 101 outputs an APD output signal S21 including the differential waveform of the gate pulses S20 with gate period. As described earlier, when the incidence of a photon signal S1 occurs while periodic gate pulses S20 are being applied, output is the APD output signal S21 in which a received-light component due to the arrival of photon is superimposed onto the differential waveform of the periodic gate pulses S20.

The APD output signal S21 is sampled by a sampling section 103 in accordance with a sampling clock signal CLKs and output as a discrete sampled waveform S22 to a gate-period waveform averaging section. The gate-period waveform averaging section includes a memory section 104, a waveform averaging section 105, and a memory control section 106. The memory section 104 stores the sampled waveform S22, from which the waveform averaging section 105 generates an averaged waveform S23.

More specifically, the sampled waveform S22 is written into the memory section 104 in time series under address control of the memory control section 106. The waveform averaging section 105 reads out this time-series sampled waveform S22 in each gate period and calculates the average level at each sampling point in the individual gate periods, thereby generating the averaged waveform S23 in a gate period.

The averaged waveform S23 thus generated is input to a phase adjuster 107, where the averaged waveform S23 is in phase with the sampled waveform S22. The phase adjuster 107 can be composed of a phase-difference detection section 14 and a phase shifting section 15 as described above. However, in the present example, the averaged waveform S23 is in phase with the sampled waveform S22 by shifting only the phase of the averaged waveform S23.

The phase-adjusted averaged waveform S23c is input to an interpolation section 108. The interpolation section 108 generates a compensated averaged waveform S30 from the averaged waveform S23c, which will be described later, and outputs the compensated averaged waveform S30 to a discrimination section 109. The discrimination section 109 receives as input the sampled waveform S22 and compensated averaged waveform S30 in accordance with the gate clock signal CLKg and determines whether or not a photon detection occurs by computing a difference between these two waveforms, thus generating a photon detection signal S31.

Incidentally, each of the gate clock signal CLKg and sampling clock signal CLKs is generated by a clock signal source 110 and a clock signal processing section 111. The gate clock signal CLKg is output to the gate generation section 102, memory control section 106, and discrimination section 109, while the sampling clock signal CLKs is output to the sampling section 103 and memory control section 106.

### 2.2) Phase Adjustment and Interpolation

Next, a description will be given of the operations for generating the compensated averaged waveform S30 by the phase adjuster 107 and interpolation section 108 in the photon detection circuit according to the present example.

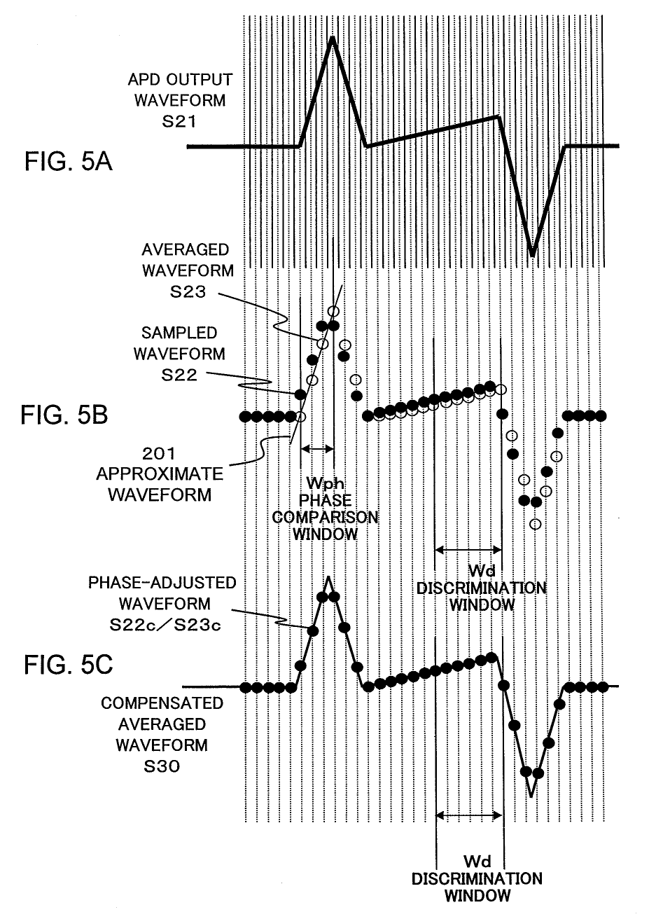

FIG. 5A is a diagram showing sampling points and the waveform of the APD output signal S21. FIG. 5B is a diagram for describing a waveform deviation of the sampled waveform S22 from the averaged waveform S23 due to a sampling jitter or the like, as well as for describing phase detection operation. FIG. 5C is a diagram showing the phase-adjusted sampled waveform S22c and averaged waveform S23c, as well as the interpolated averaged waveform.

Here, consideration will be given of a case where the sampling points deviate relative to the waveform of the APD output signal S21 shown in FIG. 5A. In this case, as shown in FIG. 5B, the phase of the sampled waveform S22 shown by filled circles is shifted relative to that of the averaged waveform S23 shown by open circles.

As describe already, when a current flows upon incidence of a photon onto the APD 101, a received-light component appears in the span indicated by a discrimination window Wd. Accordingly, the sampled waveform S22 and the averaged waveform S23 originally should have the same values at a charge pulse corresponding to the rising portion of a gate pulse. However, because of the deviation of the sampling points, a waveform difference is produced as shown by open circles and filled circles in FIG. 5B.

Therefore, according to the present example, a phase comparison window Wph is set with respect to a charge pulse corresponding to the rising portion of a gate pulse, and the phase-difference detection section 14 calculates a phase difference, to be output as a phase difference signal S24, between the sampled waveform S22 and averaged waveform S23 within the span of the phase comparison window Wph. For example, the phase difference can be obtained by calculating an approximate waveform 201, which is an approximation to the averaged waveform S23, and then calculating a time difference of the approximate waveform 201 from the sampled waveform S22. The approximate waveform 201 shown here is an example obtained by linearly approximating the averaged waveform S23 within the span of the phase comparison window Wph. The phase shifting section 15 shifts the averaged waveform S23 by the phase difference indicated by the phase difference signal 24, thereby generating the averaged waveform S23c, which is then output to the interpolation section 108.

The interpolation section 108 generates the compensated averaged waveform S30 by interpolating between the sample values of the phase-adjusted averaged waveform S23c and outputs the compensated averaged waveform S30 to the discrimination section 109. The compensated averaged waveform S30 is an averaged waveform in which a jitter of the sampling clock signal CLKs is compensated. Accordingly, the compensated averaged waveform S30 and sampled waveform S22 coincide with each other as shown in FIG. 5C, with an error in the span of the discrimination window Wd having been compensated. Consequently, an erroneous detection can be prevented.

### 2.3) Effects

According to the first example of the present invention, the sampled waveform S22 and averaged waveform S23 are in phase with each other, the phase-adjusted averaged waveform S23c is interpolated, and the interpolated averaged waveform S23c is subjected to discrimination of a photon detection. Accordingly, even if a deviation of the sampling points occurs at the sampling section 103 due to a jitter of the sampling clock signal CLKs, it is possible to perform accurate photon detection at the discrimination section 109.

### 2. SECOND EXAMPLE

It is possible to further improve precision in the interpolation of the sampled waveform, by shortening the sampling periods at the sampling section 103 in the above-described photon detection circuit according to the first example. In a photon detection circuit according to a second example of the present invention, a function of shortening the intervals at which the sampled waveform is stored into the memory section is added, with the aim of improving precision in the interpolation of the averaged waveform.

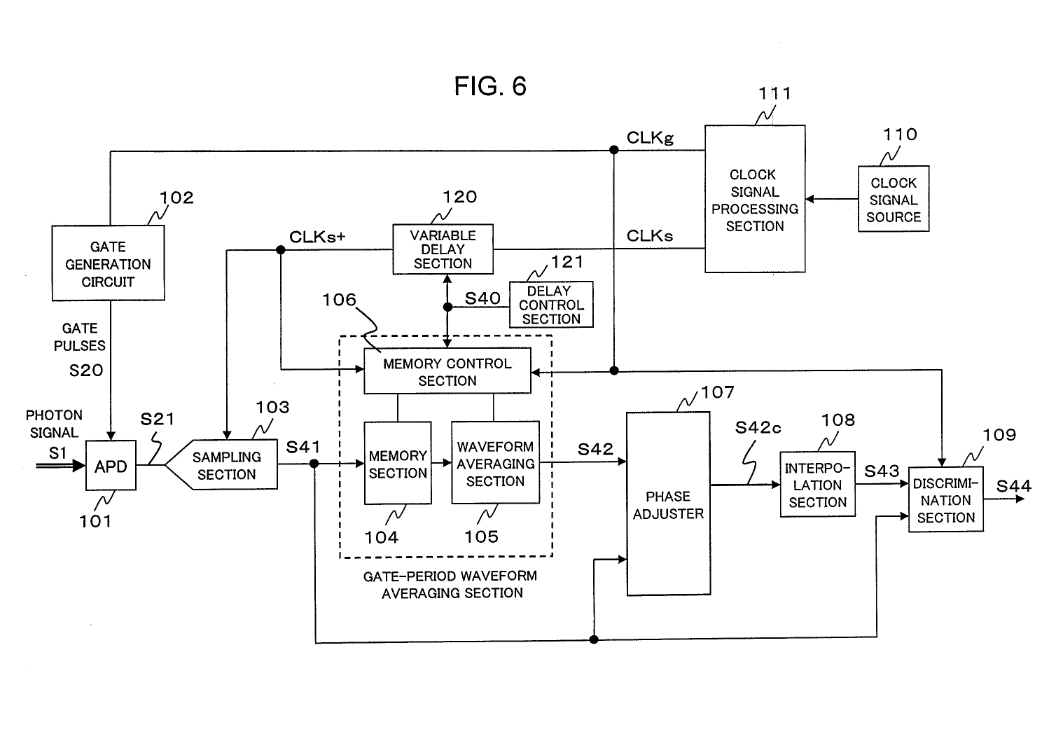

FIG. 6 is a block diagram showing a configuration of the photon detection circuit according to the second example of the present invention. Note, however, that blocks having the same functions as those of the circuit according to the first example are denoted by the same reference numerals shown in FIG. 4, and a detailed description thereof will be omitted.

In the second example, the sampling clock signal CLKs is input to a variable delay section 120 and output as a sampling clock signal CLKs+ to each of the sampling section 103 and memory control section 106. The amount of delay made at the variable delay section 102 is controlled by a delay control signal S40 from a delay control section 121, which causes the phase of the sampling clock signal CLKs to shift by an amount smaller than 2π. Thereby, it is possible to increase the sampling time resolution.

Moreover, the delay control signal S40 from the delay control section 121 is also supplied to the memory control section 106, whereby it is possible to perform control over the memory addresses of the memory section 104, reflecting the amount of delay. Specifically, the memory control section 106 performs control over a large memory address space corresponding with the number of steps for adjusting the amount of delay.

The sampling section 103 samples the APD output signal S21 in accordance with the sampling clock signal CLKs+ from the variable delay section 120, thereby generating a sampled waveform S41. The sampled waveform S41 has time resolution equivalent to the period of the sampling clock signal CLKs+. In the present example, a training sequence for generating an averaged waveform S42 with high precision is defined before the photon detection sequence is carried out, and the variable delay section 120 can be operated during this training sequence.

As an example, a description will be given of a case where the amount of delay made at the variable delay section 120 is controlled at four steps of 0, π/2, π, and 3π/2.

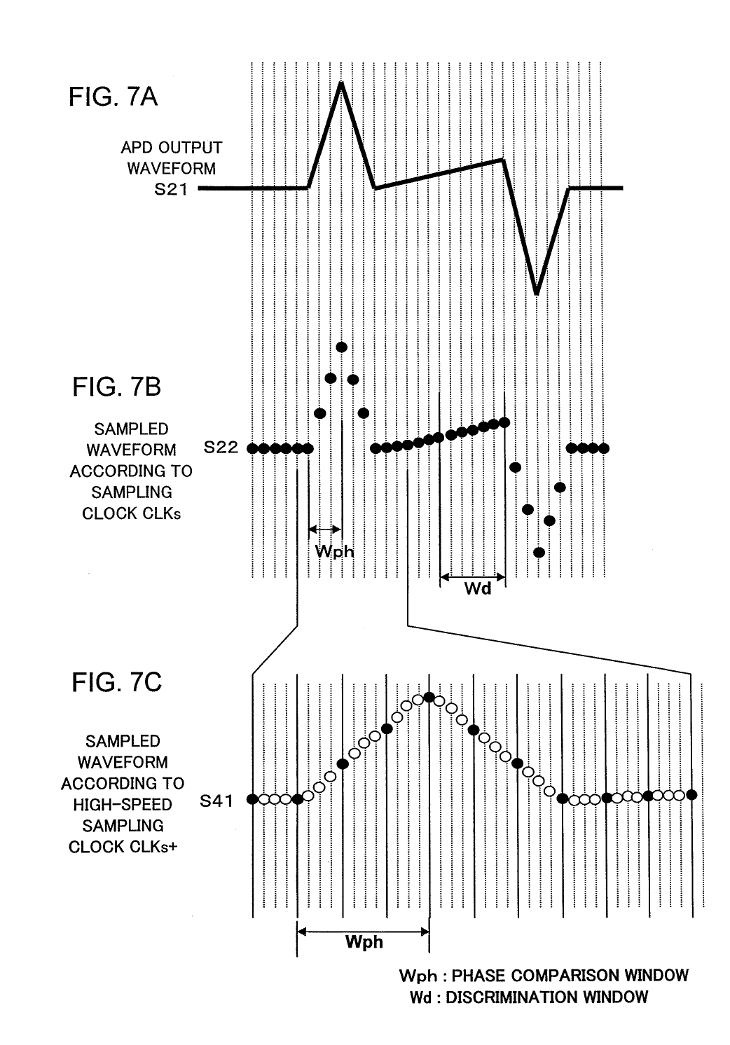

FIG. 7A is a diagram showing the waveform of the APD output signal S21, FIG. 7B is a diagram showing the sampled waveform S22 obtained in accordance with the sampling clock signal CLKs, and FIG. 7C is an enlarged diagram of a portion (charge pulse portion) of the sampled waveform S41 obtained in accordance with the sampling clock signal CLKs+, the portion between prior to and subsequent to the phase comparison window Wph.

In the present example, since the amount of delay made at the variable delay section 120 is controlled at four steps of 0, π/2, π, and 3π/2, the APD output signal S21 is sampled at four-times higher time resolution as shown by open circles in FIG. 7C, and the sampled waveform S41 is stored in the memory section 104. The memory section 104 is required to have a memory capacity corresponding with the increased resolution, that is, corresponding to the number of variable steps made at the variable delay section 120. In this case, if the delay is controlled at four steps, the memory section 104 has four times the memory capacity of the memory section 104 shown in FIG. 4.

As described above, according to the second example, the sampling clock signal CLKs is scanned through the variable delay control, and the capacity of the memory section 104 is increased so as to accommodate the increased amount of data due to such delay control, whereby the time resolution of the averaged waveform S42 generated can be increased. Thus, precision in the phase comparison processing by the phase adjuster 107 is improved. That is, even if the period of the sampling clock signal CLKs is wide compared to the time width of a charge pulse, it is possible to avoid deteriorating accuracy in the phase comparison.

### 4. THIRD EXAMPLE

According to the photon detection circuit of the second example described above, precision in the interpolation of the sampled waveform is further improved by shortening the sampling period at the sampling section 103. However, according to a photon detection circuit of a third example of the present invention, the interpolation processing can be omitted by sufficiently increasing the sampling time resolution.

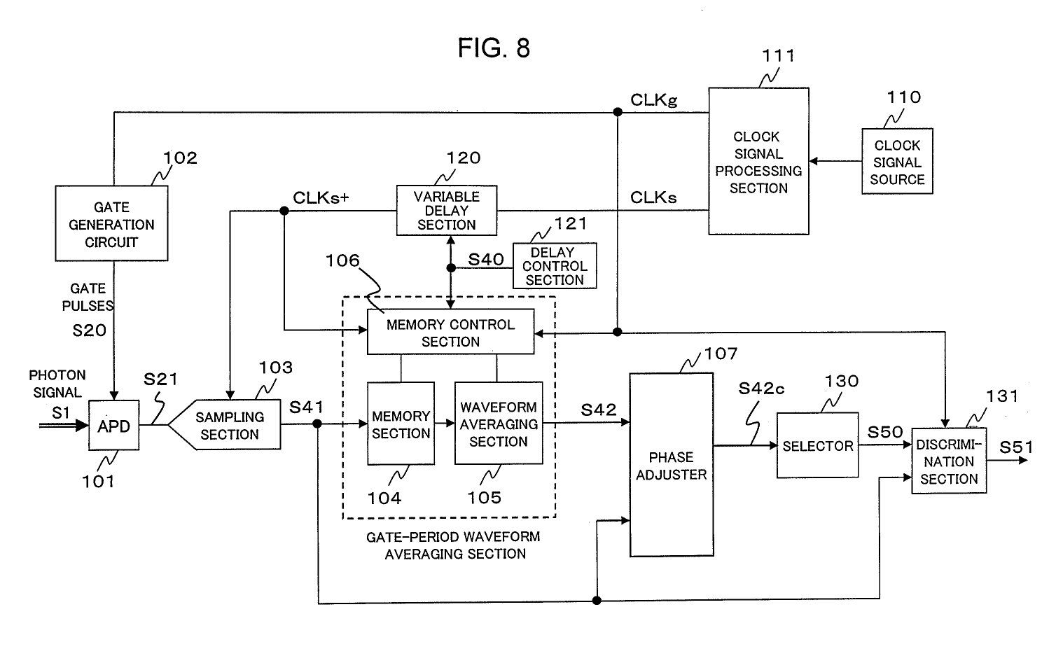

FIG. 8 is a block diagram showing a configuration of the photon detection circuit according to the third example of the present invention. Note, however, that blocks having the same functions as those of the circuit according to the second example are denoted by the same reference numerals shown in FIG. 6, and a detailed description thereof will be omitted. According to the third example, the averaged waveform S42c after phase adjustment by the phase adjuster 107 is input to a selector 130 and output by the selector 130 as a selected averaged waveform S50 to a discrimination section 131.

For example, as described above, a four-times increase in the resolution can be accomplished by controlling the amount of delay made at the variable delay section 120 at four steps of 0, π/2, π, and 3π/2. However, errors in the averaged waveform S42 can be reduced by further minutely controlling the delay. Accordingly, it is possible to generate the averaged waveform S42c having precision high enough to unnecessitate the interpolation processing, by increasing the number of steps of delay made at the variable delay section 120. In this case, since the discrimination section 131 does not require as large an amount of data as the averaged waveform S42c, the selector 130 generates from the averaged waveform S42c a selected averaged waveform S50 in an amount large enough to perform the processing in the discrimination window Wd. In other words, it is sufficient that only a portion of the averaged waveform S42c at the timings corresponding to the discrimination window Wd in a gate period is output as the selected averaged waveform S50 to the discrimination section 131.

As described above, by increasing the number of steps of delay controlled by the variable delay section 120, it is possible to generate the averaged waveform S42 having precision high enough to omit the interpolation processing. Although improving the sampling precision causes an increase in the capacity of the memory section 104, the interpolation section 108 in the first example can be omitted. Accordingly, it is possible to accomplish a reduction in the size of the processing circuit as well as a reduction in the computation time required for the interpolation processing.

### 5. FOURTH EXAMPLE

According to the above-described third example, while the interpolation processing can be omitted, the capacity of the memory section 104 is increased. Therefore, in a fourth example of the present invention, a configuration is provided that can omit the interpolation processing and also can reduce the capacity of the memory section 104.

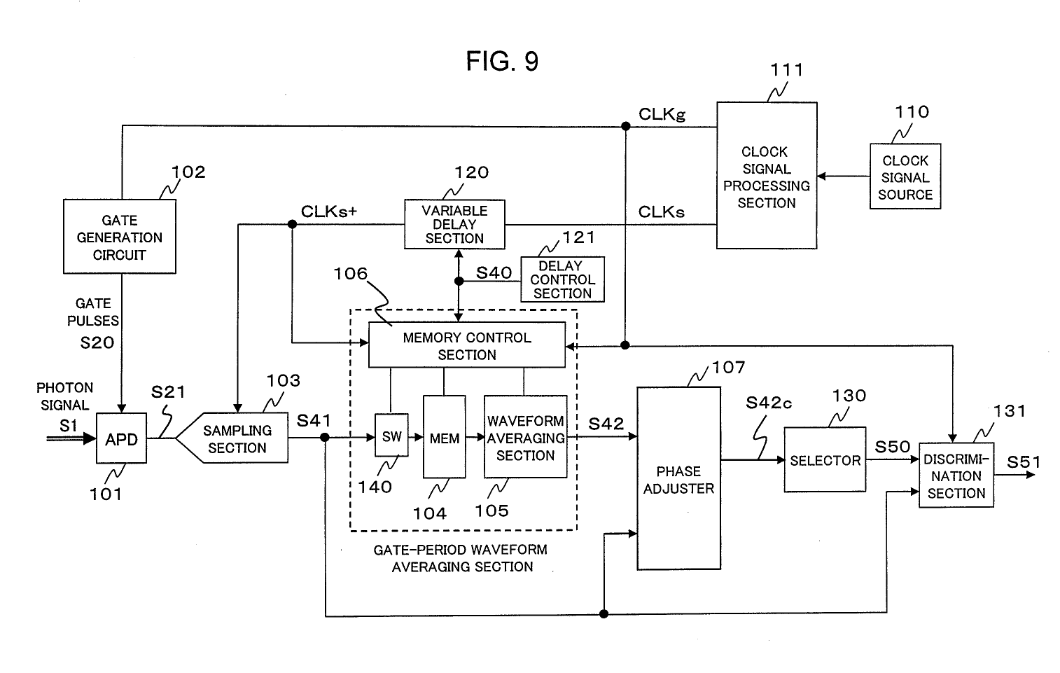

FIG. 9 is a block diagram showing a configuration of a photon detection circuit according to the fourth example of the present invention. Note that blocks having the same functions as those of the circuit according to the third example are denoted by the same reference numerals shown in FIG. 8, and a detailed description thereof will be omitted. According to the fourth example, a switch 140 is provided prior to the memory section 104 in the gate-period waveform averaging section, thereby preventing an increase in the capacity of the memory section 104.

The switch 140 selectively transmits the sampled waveform S41 to the memory section 104 under control of the memory control section 106. Specifically, since portions required of the sampled waveform S41 for the discrimination processing are only those in the time spans corresponding to the phase comparison window Wph and discrimination window Wd, the switch 140 selectively stores only the required phase portions of the sampled waveform S41 into the memory section 104. Thus, it is possible to prevent an increase in the capacity of the memory section 104. A specific operation example will be described below.

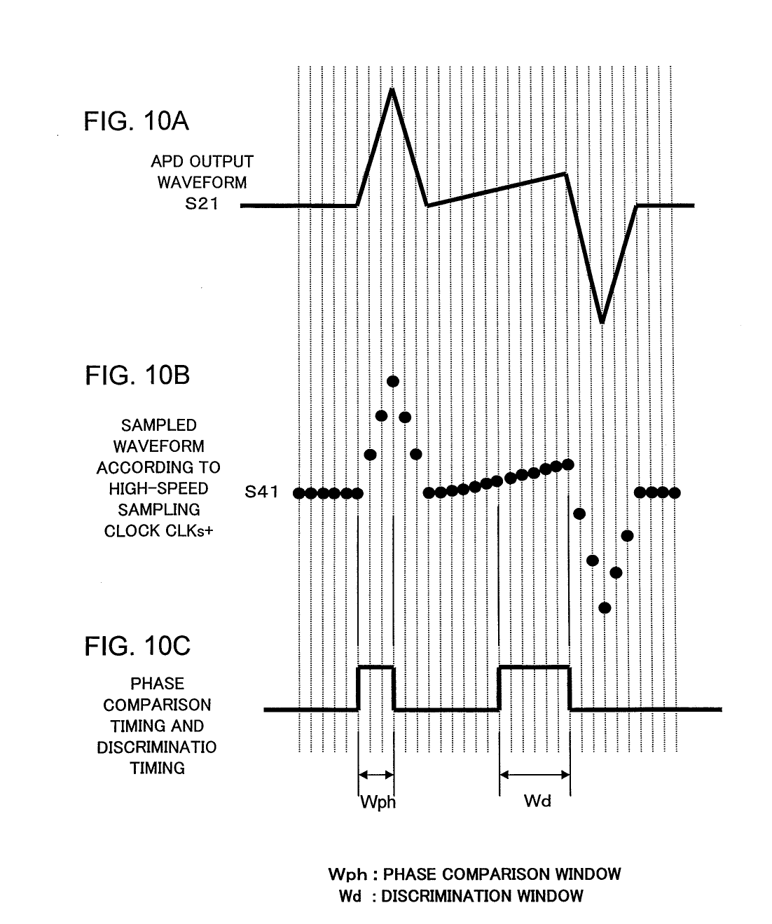

FIG. 10A is a diagram showing the waveform of the APD output signal S21, FIG. 10B is a diagram showing the sampled waveform S41 obtained in accordance with the sampling clock signal CLKs+, and FIG. 10C is a waveform diagram showing a switch timing signal for selection of the phase comparison window Wph and discrimination window Wd.

As mentioned above, portions required of the sampled waveform S41 for the discrimination processing are only those within the time spans corresponding to the phase comparison window Wph and discrimination window Wd. Therefore, it is sufficient that the switch 140 is controlled so as to transmit the sampled waveform S41 to the memory section 104 only during the time slots corresponding to the phase comparison window Wph and discrimination window Wd as shown in FIG. 10C. For example, the memory control section 106 outputs a switch control signal having a waveform as shown in FIG. 10C to the switch 140, and the switch 140 passes the sampled waveform S41 to the memory section 104 only at the phase-comparison-window timings and at the discrimination-window timings, whereby the sampled waveform S41 at the other timings is not stored in the memory section 104.

Memory control is performed as described above, whereby the interpolation processing can be omitted by sufficiently increasing the sampling time resolution, and also the capacity of the memory section 104 can be reduced.

Any one of the photon detection circuits according to the present invention can be applied to a photon detection section in any one of quantum key distribution devices, quantum cryptography devices, photon counters, optical time domain reflectmeters (OTDRs), spectrographs, dark-field cameras, and the like.

The present invention may be embodied in other specific forms without departing from the spirit or essential characteristics thereof. The above-described exemplary embodiment and examples are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A photon detection circuit comprising:
a light-receiving element to which periodic gate pulses with a predetermined period are applied;
a gate-pulse waveform averaging section for averaging sampled waveform data in the predetermined periods to generate averaged waveform data, wherein the sampled waveform data is obtained from an output signal of the light-receiving element;
a phase adjuster for adjusting at least one of phases of the averaged waveform data and the sampled waveform data so that a phase difference between the averaged waveform data and sampled waveform date disappears; and
a discriminator for discriminating photo detection based on a difference between the sampled waveform data and the averaged waveform data which are relatively phase-adjusted.

2. The photon detection circuit according to claim 1, wherein the phase adjuster comprises a phase difference detector for detecting the phase difference in a phase comparison window which is a span of time corresponding to a rising portion of a gate pulse of the periodic gate pulses.

3. The photon detection circuit according to claim 2, wherein the span of time corresponds to a high rate of change in amplitude of the output signal of the light-receiving element, the high rate of change being greater than a predetermined value.

4. The photon detection circuit according to claim 1, wherein the discriminator discriminates photo detection in a discrimination window which is different in time from a span of time in which the phase difference between the sampled waveform data and the averaged waveform data is detected.

5. The photon detection circuit according to claim 2, wherein the discriminator discriminates photo detection in a discrimination window which is different in time from a span of time in which the phase difference between the sampled waveform data and the averaged waveform data is detected.

6. The photon detection circuit according to claim 1, further comprising:
an interpolation section for interpolating the averaged waveform data phase-adjusted to produce interpolated averaged waveform data,
wherein the discriminator discriminates photo detection based on a difference between the sampled waveform data and the interpolated averaged waveform data.

7. The photon detection circuit according to claim 2, further comprising:
an interpolation section for interpolating the averaged waveform data phase-adjusted to produce interpolated averaged waveform data,
wherein the discriminator discriminates photo detection based on a difference between the sampled waveform data and the interpolated averaged waveform data.

8. The photon detection circuit according to claim 1, further comprising:
a variable delaying section for scanning a phase of a sampling clock in predetermined steps when the output signal of the light-receiving element is sampled according to the sampling clock to obtain the sampled waveform data; and
a storage section for storing more densely sampled waveform data in the predetermined periods, wherein the more densely sampled waveform data is obtained by scanning the phase of the sampling clock,
wherein the gate-pulse waveform averaging section inputs the more densely sampled waveform data as the sampled waveform data in the predetermined periods.

9. The photon detection circuit according to claim 2, further comprising:
a variable delaying section for scanning a phase of a sampling clock in predetermined steps when the output signal of the light-receiving element is sampled according to the sampling clock to obtain the sampled waveform data; and
a storage section storing more densely sampled waveform data in the predetermined periods, wherein the more densely sampled waveform data is obtained by scanning the phase of the sampling clock,
wherein the gate-pulse waveform averaging section inputs the more densely sampled waveform data as the sampled waveform data in the predetermined periods.

10. The photon detection circuit according to claim 8, further comprising:
a selector for selecting a portion of the average waveform data corresponding to a discrimination window to output it to the discrimination section, wherein the discrimination window is different in time from a span of time in which the phase difference between the sampled waveform data and the averaged waveform data is detected.

11. The photon detection circuit according to claim 9, further comprising:
a selector for selecting a portion of the average waveform data corresponding to a discrimination window to output it to the discrimination section, wherein the discrimination window is different in time from a span of time in which the phase difference between the sampled waveform data and the averaged waveform data is detected.

12. The photon detection circuit according to claim 8, further comprising:
a switch for storing only first and second portions of the sampled waveform data into the storage section, the first portion corresponding to a phase comparison window which is a span of time for detection of the phase difference between the sampled waveform data and the averaged waveform data, the second portion corresponding to a discrimination window which is different in time from the phase comparison window.

13. The photon detection circuit according to claim 9, further comprising:
a switch for storing only first and second portions of the sampled waveform data into the storage section, the first portion corresponding to a phase comparison window which is a span of time for detection of the phase difference between the sampled waveform data and the averaged waveform data, the second portion corresponding to a discrimination window which is different in time from the phase comparison window.

14. A photon detection method using a light-receiving element to which periodic gate pulses with a predetermined period are applied, comprising:
averaging sampled waveform data in the predetermined periods to generate averaged waveform data, wherein the sampled waveform data is obtained from an output signal of the light-receiving element;
adjusting at least one of phases of the averaged waveform data and the sampled waveform data so that a phase difference between the averaged waveform data and sampled waveform date disappears; and
discriminating photo detection based on a difference between the sampled waveform data and the averaged waveform data which are relatively phase-adjusted.

15. The photon detection method according to claim 14, wherein the phase difference is detected in a phase comparison window which is a span of time corresponding to a rising portion of a gate pulse of the periodic gate pulses.

16. The photon detection method according to claim 15, wherein the span of time corresponds to a high rate of change in amplitude of the output signal of the light-receiving element, the high rate of change being greater than a predetermined value.

17. The photon detection method according to claim 14, wherein photo detection is discriminated in a discrimination window which is different in time from a span of time in which the phase difference between the sampled waveform data and the averaged waveform data is detected.

18. The photon detection method according to claim 15, wherein photo detection is discriminated in a discrimination window which is different in time from a span of time in which the phase difference between the sampled waveform data and the averaged waveform data is detected.

19. The photon detection method according to claim 14, further comprising:
interpolating the averaged waveform data phase-adjusted to produce interpolated averaged waveform data,
wherein photo detection is discriminated based on a difference between the sampled waveform data and the interpolated averaged waveform data.

20. The photon detection method according to claim 15, further comprising:
interpolating the averaged waveform data phase-adjusted to produce interpolated averaged waveform data,
wherein photo detection is discriminated based on a difference between the sampled waveform data and the interpolated averaged waveform data.

21. The photon detection method according to claim 14, further comprising:
scanning a phase of a sampling clock in predetermined steps when the output signal of the light- receiving element is sampled according to the sampling clock to obtain the sampled waveform data; and
storing more densely sampled waveform data in the predetermined periods into a storage section, wherein the more densely sampled waveform data is obtained by scanning the phase of the sampling clock,
wherein the gate-pulse waveform averaging section inputs the more densely sampled waveform data as the sampled waveform data in the predetermined periods.

22. The photon detection method according to claim 15, further comprising:
scanning a phase of a sampling clock in predetermined steps when the output signal of the light- receiving element is sampled according to the sampling clock to obtain the sampled waveform data; and
storing more densely sampled waveform data in the predetermined periods into a storage section, wherein the more densely sampled waveform data is obtained by scanning the phase of the sampling clock,
wherein the gate-pulse waveform averaging section inputs the more densely sampled waveform data as the sampled waveform data in the predetermined periods.

23. The photon detection method according to claim 21, further comprising:
selecting a portion of the average waveform data corresponding to a discrimination window to output it to the discrimination section, wherein the discrimination window is different in time from a span of time in which the phase difference between the sampled waveform data and the averaged waveform data is detected.

24. The photon detection method according to claim 22, further comprising:
selecting a portion of the average waveform data corresponding to a discrimination window to output it to the discrimination section, wherein the discrimination window is different in time from a span of time in which the phase difference between the sampled waveform data and the averaged waveform data is detected.

25. The photon detection method according to claim 21, further comprising:
storing only first and second portions of the sampled waveform data into the storage section, the first portion corresponding to a phase comparison window which is a span of time for detection of the phase difference between the sampled waveform data and the averaged waveform data, the second portion corresponding to a discrimination window which is different in time from the phase comparison window.

26. The photon detection method according to claim 21, further comprising:
storing only first and second portions of the sampled waveform data into the storage section, the first portion corresponding to a phase comparison window which is a span of time for detection of the phase difference between the sampled waveform data and the averaged waveform data, the second portion corresponding to a discrimination window which is different in time from the phase comparison window.

27. A computer program instructing a program-controlled processor to perform a photon detection method using a light-receiving element to which periodic gate pulses with a predetermined period are applied, comprising:
averaging sampled waveform data in the predetermined periods to generate averaged waveform data, wherein the sampled waveform data is obtained from an output signal of the light-receiving element;
adjusting at least one of phases of the averaged waveform data and the sampled waveform data so that a phase difference between the averaged waveform data and sampled waveform date disappears; and
discriminating photo detection based on a difference between the sampled waveform data and the averaged waveform data which are relatively phase-adjusted.

28. The computer program according to claim 27, wherein the phase difference is detected in a phase comparison window which is a span of time corresponding to a rising portion of a gate pulse of the periodic gate pulses.
